(19) United States
(12) Patent Application Publication
(10) Pub. No.: US 2014/0231114 A1
(43) Pub. Date: Aug. 21, 2014

(54) POWER DRILL

(71) Applicant: Peter SCHENK, Niederstotzingen (DE)

(72) Inventor: Peter SCHENK, Niederstotzingen (DE)

(21) Appl. No.: 14/182,653

(22) Filed: Feb. 18, 2014

(30) Foreign Application Priority Data
Feb. 20, 2013 (DE) 102013101679.0

(51) Int. Cl. B23B 45/02; B25F 5/00

(52) U.S. Cl. CPC B23B 45/02; B25F 5/001; B23Q 2005/005
USPC 173/20; 173/47

(57) ABSTRACT

A power drill shiftable between at least two operational modes has a drill housing, a brushless dc motor in the housing, a drive spindle rotatable about an axis, and a chuck body adjacent the housing. Two elements interconnected by a screwthread are relatively axially shiftable on relative rotation about the axis, and gripping jaws between the chuck body and one of the elements are relatively shiftable radially of the axis on relative axial shifting of the elements. A drive sleeve rotatable by the motor about the axis is connected to the other of the elements. A member is shiftable between positions corresponding to the operational modes of the power drill. A sensor detects which mode the power drill is in, and motor-control means connected between the sensor and the motor adjusts a parameter of the motor as a function of the mode detected by the sensor.

### FIELD OF THE INVENTION

The present invention relates to a drill. More particularly this invention concerns a power drill with a power-assisted but manually operable chuck.

### BACKGROUND OF THE INVENTION

A typical power drill has a power unit having a housing holding a motor and a rotatable drill spindle, and a drill chuck including a chuck body in which adjustable jaws are guided between a threaded element and a threaded counter-element connected by screwthreads. The chuck also has a drive sleeve rotationally fixed to the threaded counter-element and drivable by the motor.

### BACKGROUND OF THE INVENTION

A power drill of the above-described type has been disclosed in U.S. 2012/0274035. It can be switched between “tool-change” and “drill,” the same torque being generated by the motor in both operating modes and transmitted to the drill spindle. However, this is disadvantageous in the tool-change operating mode since the highest speed and full torque are effective both when the jaws encounter the drilling tool and when the jaws are moved to the maximum opening width, and as a result the mechanical components are put under very high load. A development of the above-referenced power drill described in US 2013/0133908 has therefore provided the ability to allow varying torque loads in different operating modes. This is accomplished by a mechanical approach which, however, necessitates a significantly higher cost in terms of designing and manufacturing the power drill.

### OBJECTS OF THE INVENTION

It is therefore an object of the present invention to provide an improved power drill.

Another object is the provision of such an improved power drill that overcomes the above-given disadvantages, in particular that enables varying torque loads on the power drill in different operating modes.

### SUMMARY OF THE INVENTION

A power drill shiftable between at least two operational modes has according to the invention a drill housing, a brushless dc motor in the housing, a drive spindle rotatable about an axis, and a chuck body adjacent the housing. Two elements interconnected by a screwthread are relatively axially shiftable on relative rotation about the axis, and gripping jaws between the chuck body and one of the elements are relatively shiftable radially of the axis on relative axial shifting of the elements. A drive sleeve rotatable by the motor about the axis is connected to the other of the elements. A member is shiftable between positions corresponding to the operational modes of the power drill. A sensor detects which mode the power drill is in, and motor-control means connected between the sensor and the motor adjusts a parameter of the motor as a function of the mode detected by the sensor.

Brushless DC motors as a variant DC motor are well-known in the prior art where an electronic circuit replaces the otherwise conventional mechanical commutator with brushes to effect commutation. The use of these brushless DC motors provides an elegant means of achieving the object of intervening precisely in the motor control so overloading the apparatus's components in the tool-change operating mode is prevented in an essentially unchanged design of the above-described power drill through the sensor-based detection of the operating mode by the appropriate motor control. The preferred approach according to the invention is one in which the sensor for detecting the position of a control element that switches and/or displays the operating mode is designed so as to take into account whether any change in the operating mode must be effected intentionally through an appropriate control element by the user, the position of the control element being evaluated by the sensor, that is, in particular, the sensor is designed to differentiate between a tool-change mode for the purpose of opening and closing the jaws and a drilling mode for the drilling action. Provision is thus made according to the invention whereby the motor control is capable of changing the torque and/or the speed of the motor as a function of the operating mode detected by the sensor.

An embodiment that is preferred in terms of its simplicity of constructive design is characterized in that a planetary-gear transmission is provided between the DC motor and the drive sleeve. This planetary-gear transmission includes a sun gear drivable by the DC motor and engaging at least one planet gear supported on a planet carrier attached to the drive sleeve, the planet gear(s) in turn meshing with a ring gear carried by the housing.

The threaded counter-element according to the invention is of two-part design composed of a threaded sleeve and a coupling rod rotationally fixed to this sleeve, axially adjustable, and guided within the hollow drill/machine spindle. Here the coupling rod includes a rod gear and the tube shaft includes an element gear, and the drive sleeve, and optionally the transmission, is/are mounted in axially adjustable fashion in the housing. This provides a constructively simple means of creating a torque-transmitting linkage between the drive sleeve and the tube shaft or coupling rod.

An especially preferred embodiment is characterized in that the drive sleeve has internal teeth and can be switched between the tool-change mode in which the rod gear engages the internal teeth to the drilling mode in which the rod gear and the element gear both engage the internal teeth. The element gear engages the ring gear in the tool-change mode, with the result that the tube shaft is rotationally fixed to the housing and the is chuck body. The relative rotation of the coupling rod is ensured vis-a-vis the tube shaft. The power drill can be switched very easily back and forth between the tool-change mode and the drilling mode by axially adjusting the drive sleeve. Due to the fact that the rod gear and the element gear are driven by the drive sleeve, any relative motion of the threaded element is also prevented vis-a-vis the threaded counter-element.

It has furthermore proven advantageous if an adjustment sleeve that axially adjusts the transmission and the drive sleeve is associated with the housing, where in this case the preferred approach according to the invention is for the sensor to be designed to detect the position of the drive sleeve and/or of the adjustment sleeve.

### BRIEF DESCRIPTION OF THE DRAWING

The above and other objects, features, and advantages will become more readily apparent from the following description, reference being made to the accompanying drawing in which:

FIG. 1 is a longitudinal section through the power drill in the tool-change mode;

FIG. 1a is section taken along line 1A-1A of FIG. 1;

FIG. 1b is a side view of the structure as shown in FIG. 1;

FIG. 2 shows the power drill of FIG. 1 in the drilling mode;

FIG. 2a is a side view of the structure as shown in FIG. 2;

FIG. 3 is section taken along line III-III of FIG. 2; and

FIG. 4 is a schematic view of a power drill with motor control and a brushless DC motor.

### SPECIFIC DESCRIPTION OF THE INVENTION

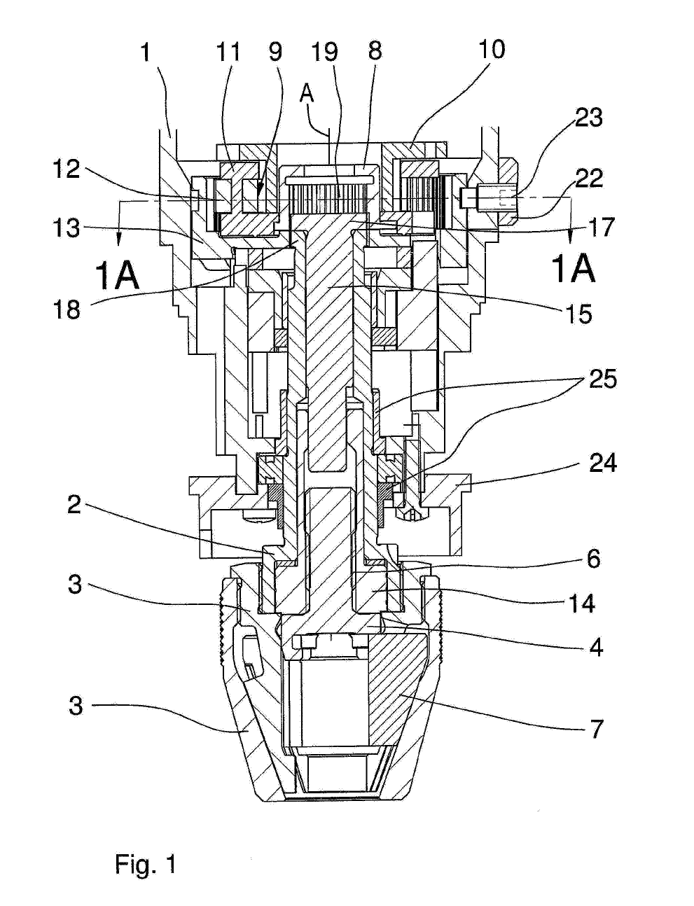

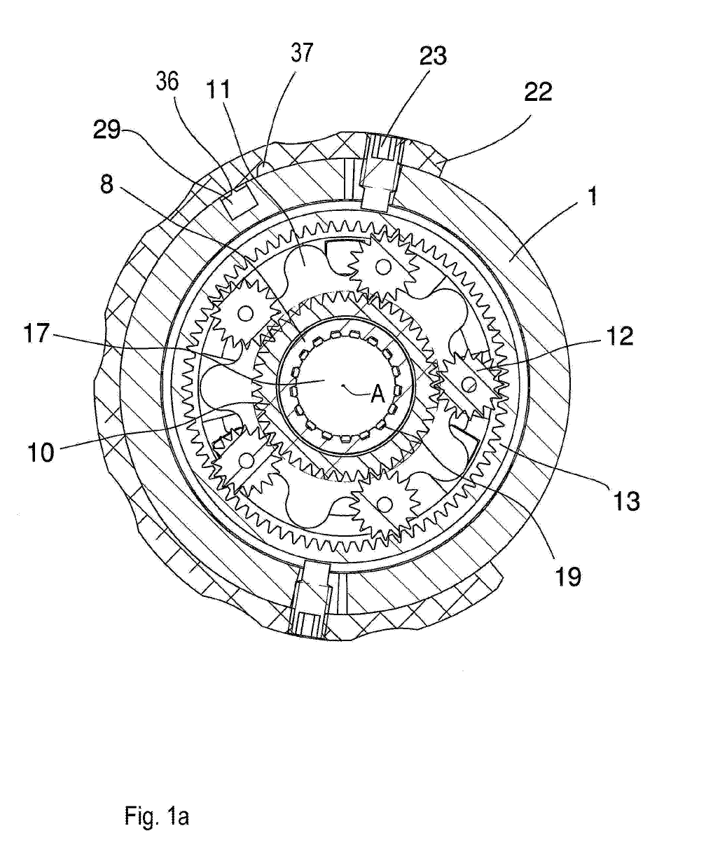

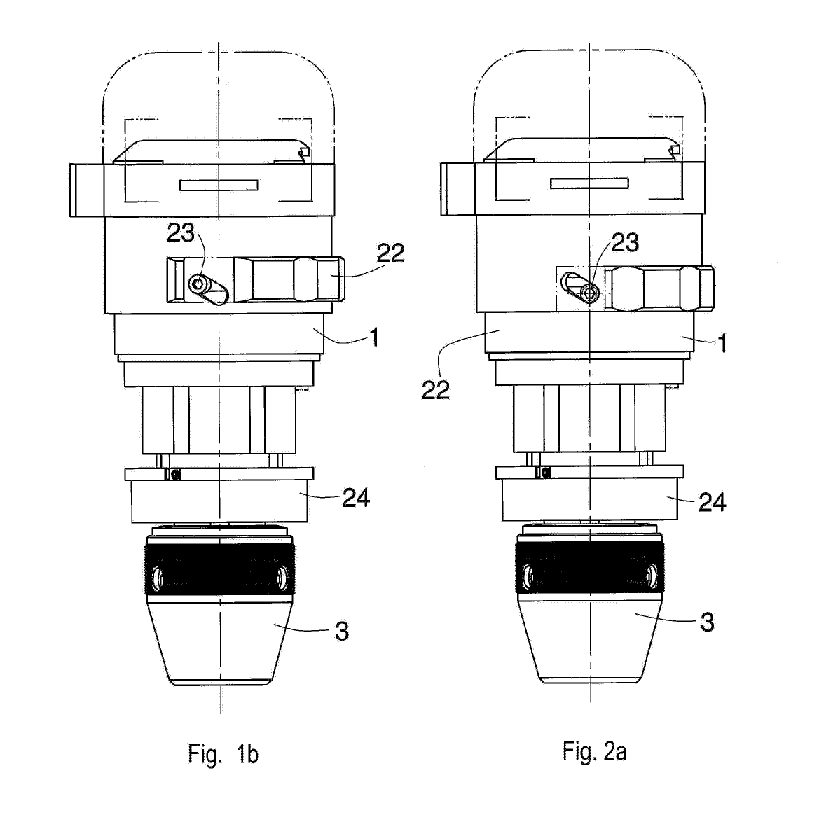

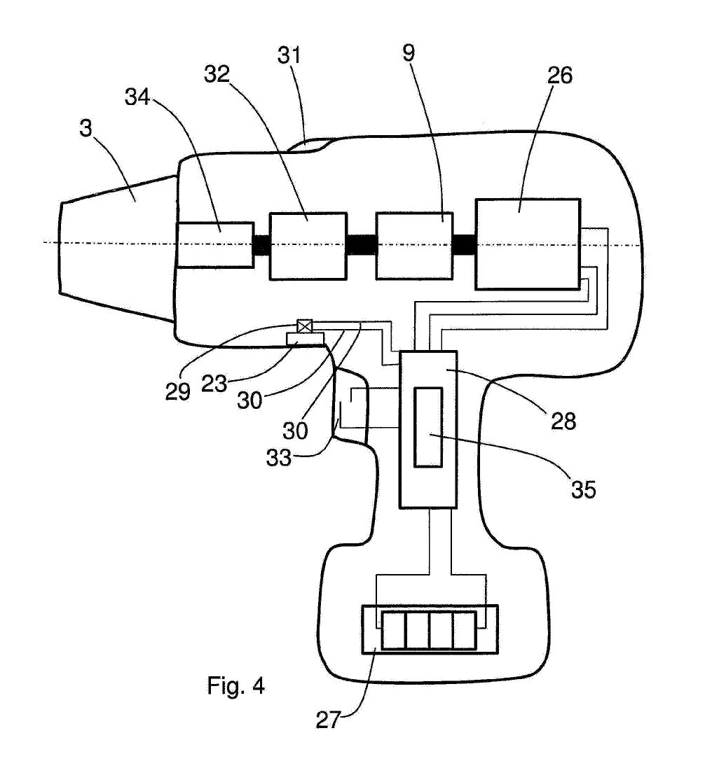

A power drill as shown schematically in FIG. 4 and in more detail in FIGS. 1-3 has a power unit including a housing 1 holding a motor 26 rotating a tubular drill spindle about an axis A. A drill chuck on the spindle has a chuck body 3 in which adjustable jaws 7 are guided between a threaded element 4 and a threaded counter-element 14, 15 interconnected by screwthreads 6. A drive sleeve 8 rotationally coupled to the threaded counter-element 14, 15 can be driven by the motor 26 provided in the power unit. A planetary-gear transmission 9 provided between the motor 26 and the drive sleeve 8 has a sun gear 10 drivable by the motor 26.

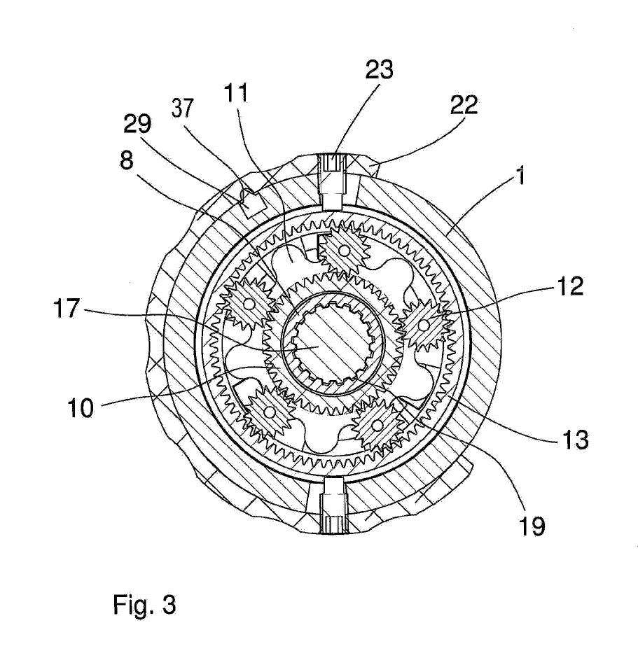

FIGS. 1a and 3 show that in this embodiment exactly five planet gears 12 are mounted on a planet carrier 11 attached to the drive sleeve 8 and engage the sun gear 10 and a coaxial ring gear 13 fixed in the housing 1. It is also possible according to the invention to use more or fewer planet gears 12.

The threaded counter-element 14, 15 is of two-part design, formed by a threaded sleeve 14 and a coupling rod 15 axially movable in and rotationally coupled by splines to this sleeve 14 and journaled in the drill spindle 2. The coupling rod 15 has a rod gear 17, and the drive spindle 2 has an identical element gear 18 axially immediately thereadjacent.

The planetary-gear transmission 9 and drive sleeve 8 are axially shiftable in the housing 1. An adjustment sleeve 22 on the housing 1 can axially move the planetary-gear transmission 9 and the drive sleeve 8. The adjustment sleeve 22 includes for this purpose an adjustment element 23 that fits with the ring gear 13.

A cover cap 24 releasably attached to and axially in front of the housing 1 is releasably attached to the housing 1. Several journals 25 are provided between the drill spindle 2 and the housing 1.

FIG. 1 shows the embodiment in the tool-change mode in which internal teeth 19 of the drive sleeve 8 engage the rod gear 17 while the element gear 18 meshes with the non-rotating ring gear 13. This mode transmits power from the motor 26 through the machine spindle 2 to the sun gear 10 of the planetary-gear transmission 9. This gear 10 drives the planet gears 12 mounted on planet carrier 11 so they roll on the ring gear 13 rotationally fixed to the housing 1. The drive sleeve 8 rotationally fixed to the planet carrier 11 in turn transmits the force to the rod gear 17, thereby driving the coupling rod 15 and the threaded sleeve 14. Since the element gear 18 and the drive spindle 2 are rotationally fixed to the housing 1, this enables the threaded sleeve 14 to rotate relative to the drive spindle 2, and the threaded counter-element 14, 15 is moved axially forward by the threaded connection 6, that is, in a direction away from the motor 26, or axially rearward, while entraining the jaws 7.

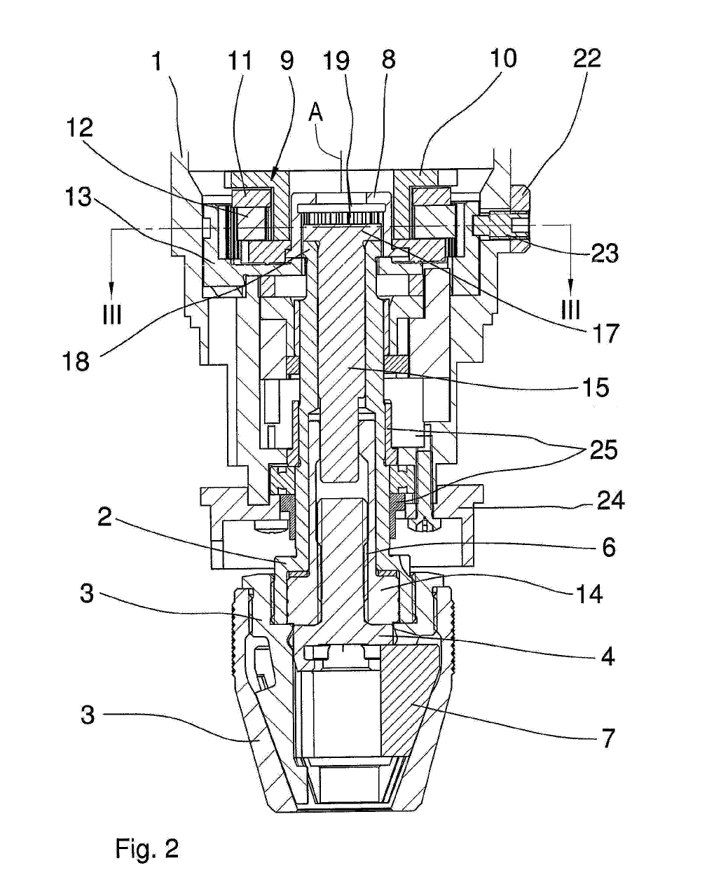

FIG. 2 shows the drilling mode in which the drive sleeve 8 and the planetary-gear transmission 9 are shifted axially forward such that rod gear 17 and element gear 18 both engage the internal teeth 19 of the drive sleeve 8. Here too the power from the motor 26 is transmitted to the sun gear 10 of the planetary-gear transmission 9. This gear 10 drives the planet gears 12 mounted on the planet carrier 11 so they roll along the ring gear 13 rotationally fixed to the housing 1. The drive sleeve 8 here is shifted axially forward by the adjustment sleeve 22. The drive sleeve 8 is carried by the planetary-gear transmission 9, and is now rotationally fixed to the coupling rod 15 and to the drive spindle 2 through engagement of the rod gear 17 and of the element gear 18 with the internal teeth 19 of the drive sleeve 8, with the result that power from the motor 26 is transmitted directly to the coupling rod 15 and the drive spindle 2. As a result, there is no relative rotation between the threaded sleeve 14 and the drive spindle 2, and shifting of the jaws 7 are possible.

According to the invention as shown in FIG. 4, the motor 26 in this type of power drill is a brushless DC motor with a motor control 28 connected by a sensor lead 30 to a sensor 29 for detecting the operating mode. At least one motor parameter can be modified by the motor control 28 as a function of the operating mode detected by the sensor 29. The sensor 29 differentiates here between the tool-change mode and the drilling mode by detecting the position of the adjustment sleeve 22, as indicated in the drawing, the adjustment sleeve 22 being shown in the tool-change mode in FIG. la and in the drilling mode in FIG. 3. This differentiation is possible simply in that the sensor 29 uses a sensor pin 37 (FIG. 1a) to detect the presence or absence of a recess 36 in the adjustment sleeve 22 depending on the rotational position of the adjustment sleeve 22. Alternatively, it is similarly possible for the sensor 29 to be capable of detecting the position of the drive sleeve 8 relative to the element gear 18; however, this requires placing the sensor 29 at a more inaccessible location as compared with assessing the position of the adjustment sleeve 22.

The power drill schematically illustrated in FIG. 4 thus enables the position of a mechanical control element 22 to be evaluated, which element indicates the various operating modes so as to intervene in the motor control 28 as a function of the data acquired by the sensor 29 in order to provide the full torque and maximum rotational speed in the power drill mode, yet reduce the torque and/or speed in the tool-change mode. Thus no mechanical coupling disengagement or interruption of power transmission occurs during coupling. These approaches can be achieved only at a high cost in terms of constructive design; instead, the drill spindle 2 is stopped by the motor control 28 once the preset torque has been reached, thereby achieving in this way a limitation of torque. The value for the limitation of torque does not have to be the same for clamping and releasing, so that it is conceivable to increase the torque as an opening reserve for release.

The invention can also be combined with the power drill described in above-cited U.S. 2013/0133908, and reference is made to the disclosure content thereof for an explanation of the mechanical torque limitation and as a supplement regarding the electronic limitation of torque.

It must also be mentioned that brushless DC motor 26 is preferably supplied with direct current from a battery 27; however, it is equally possible to apply the invention to a power drill that can be connected through a wire to grid-based power as long as a rectifier is provided to convert the alternating current to direct current.

I claim:

1. A power drill shiftable between at least two operational modes, the drill comprising:
a drill housing;
a brushless dc motor in the housing;
a drive spindle rotatable about an axis;
a chuck body adjacent the housing;
two elements interconnected by a screwthread and relatively axially shiftable on relative rotation about the axis;
gripping jaws engaged between the chuck body and one of the elements and relatively shiftable radially of the axis on relative axial shifting of the elements;
a drive sleeve rotatable by the motor about the axis and connected to the other of the elements;
a member shiftable between positions corresponding to the operational modes of the power drill;
a sensor for detecting which mode the power drill is in; and
motor-control means connected between the sensor and the motor for adjusting a parameter of the motor as a function of the mode detected by the sensor.

2. The power drill defined in claim 1, wherein the member is a mode-adjust member shiftable on the housing.

3. The power drill defined in claim 1, wherein the member indicates the mode of the power drill.

4. The power drill defined in claim 1, wherein the modes are a tool-change mode in which the motor rotates the drive sleeve at low speed or low torque and a drill mode in which the motor rotates the drive sleeve at high speed or high torque.

5. The power drill defined in claim 1, further comprising:
a planetary gear transmission between the drive sleeve and the motor.

6. The power drill defined in claim 5, wherein the planetary-gear transmission includes
a sun gear rotatable by the motor about the axis,
a planet carrier rotatable about the axis and connected to on the drive sleeve;
planet gears on the carrier meshing with the sun gear; and
a ring gear generally nonrotatable on the housing and meshing with the planet gears.

7. The power drill defined in claim 1, wherein the other element is formed by an element sleeve held threaded on the one element and a rod rotationally coupled to the element sleeve and axially movable relative thereto.

8. The power drill defined in claim 7, wherein the rod has a rod gear and the element sleeve has a element gear immediately adjacent the rod gear.

9. The power drill defined in claim 8, wherein the drive sleeve is internally toothed and fittable the rod gear and element gear and axially relatively displaceable between a position corresponding to the drill mode and fitting over both the rod gear and the element gear and a position corresponding to the tool-change mode and fitting only with the rod gear.

10. The power drill defined in claim 9, wherein the member is coupled to the drive sleeve to axially displace it on movement between the tool-change and drill modes.

11. The power drill defined in claim 9, further comprising:
a planetary-gear drive between the drive spindle and the motor and axially shiftable with the drive spindle.

12. The power drill defined in claim 1, wherein the sensor means detects the position of the drive sleeve or of the member.
